(19) United States
(12) Patent Application Publication
(10) Pub. No.: US 2026/0292600 A1
(43) Pub. Date: Sep. 24, 2026

(54) MANAGEMENT OF DATA COMMUNICATION APPLICATION PROGRAMMING INTERFACE (API) SUBSCRIPTIONS

(71) Applicant: T-MOBILE INNOVATIONS LLC, Overland Park, KS (US)

(72) Inventor: Zenaida Castro Canlas-Factora, Renton, WA (US)

(21) Appl. No.: 19/088,751

(22) Filed: Mar. 24, 2025

(51) Int. Cl. H04W 28/24; G06F 9/54; H04W 76/30

(52) U.S. Cl. CPC H04W 28/24; G06F 9/547; H04W 76/30

(57) ABSTRACT

An exemplary data system comprises a user-control portal and a communication network. The user-control portal activates an Application Programming Interface (API) subscription. The user-control portal determines a termination condition for automatically terminating the API subscription. The user-control portal receive a user request and responsively calls an API in the API subscription to modify a data communication service for a user communication device. In response to the API call, the user-control portal directs a communication network to modify the data communication service for the user communication device. The communication network modifies the data communication service for the user communication device. The user-control portal detects the termination condition has been met, and in response, automatically terminates the API subscription for the user communication device.

### TECHNICAL BACKGROUND

Data systems provide data services to user devices like phones and computers. The data services include internet-access, machine-communications, media-streaming, or some other data product. For example, a fleet of aerial vehicles may use a wireless communication network for vehicle tracking and control. In another example, a team of gamers may use internet access to play an interactive game. The data systems comprise network elements that interface with consumers to enable the consumers to manage their data services. The network elements subscribe to Application Programming Interfaces (APIs) from the data system, and then the network elements call these APIs to implement the consumer control.

For example, a consumer may interact with a network element that subscribes to and calls an API to improve the Quality-of-Service (QoS) for one of their wireless phones. The consumer may want a higher data rate on a data session for the wireless phone. In response to a user request, the network element calls an API on the data system to increase the data rate. The data system responds to the API call by increasing the data rate on the data session. Once the data session is terminated, the API is no longer used.

Although the data system has techniques to terminate APIs when they are no longer used, errors may cause some of these API subscriptions to remain. For example, a signaling message to terminate an API subscription from a Policy Control Function (PCF) to a Network Exposure Function (NEF) may be lost, and the unwanted API subscription may remain in the NEF. In another example, a signaling message to terminate an API subscription from an Application Function (AF) to a NEF may be lost, and the unwanted API subscription may remain in the NEF.

These unwanted and unused API subscriptions burden the data systems with additional cost and degraded performance. A NEF with excessive unused API subscriptions is costlier to operate because more memory is required. A NEF with excessive unused API subscriptions does not perform as well because processing resources are wasted by processing unused APIs to find and use active APIs.

### TECHNICAL OVERVIEW

An exemplary data system comprises a user-control portal and a communication network. The user-control portal activates an Application Programming Interface (API) subscription. The user-control portal determines a termination condition to automatically terminate the API subscription. The user-control portal calls the API to modify a data communication service for a user communication device, and in response, directs a communication network to modify the data communication service for the user communication device. The communication network responsively modifies the data communication service for the user communication device. The user-control portal detects the termination condition, and in response, automatically terminates the API subscription for the user communication device.

In some examples, a method comprises the following operations. Activate an API subscription. Determine a termination condition to automatically terminate the API subscription. Receive an API call for the API subscription to modify a data communication service for a user communication device. Modify the data communication service for the user communication device in response to the API call. Detect the termination condition, and in response, automatically terminate the API subscription for the user communication device.

In some examples, a method comprises the following operations. An Application Function (AF) receives a user request and responsively requests an API subscription from a Network Exposure Function (NEF). The NEF activates the API subscription for the AF. The NEF determines a termination condition to automatically terminate the API subscription. The AF calls the subscribed API on the NEF to modify the quality-of-service of a wireless communication bearer for a user communication device. The NEF signals a wireless network element to modify the quality-of-service of the wireless communication bearer for the user communication device in response to the API call. The NEF determines that the termination condition has been met, and in response, automatically terminates the API subscription.

### DESCRIPTION OF THE DRAWINGS

FIG. 1 illustrates an exemplary data system to automatically terminate Application Programming Interface (API) subscriptions.

FIG. 2 is a flow diagram that illustrates exemplary operations of the data system to automatically terminate the API subscriptions.

FIG. 3 is a protocol diagram that illustrates exemplary operations of the data system to automatically terminate the API subscriptions.

FIG. 4 illustrates exemplary processing circuitry to automatically terminate API subscriptions.

FIG. 5 illustrates an exemplary wireless communication network to automatically terminate the API subscriptions.

FIG. 6 illustrates an exemplary User Equipment (UE) in the wireless communication network that automatically terminates the API subscriptions.

FIG. 7 illustrates an exemplary terrestrial 5GNR AN in the wireless communication network that automatically terminates the API subscriptions.

FIG. 8 illustrates an exemplary Wireless Fidelity (WIFI) AN in the wireless communication network that automatically terminates the API subscriptions.

FIG. 9 illustrates an exemplary Satellite (SAT) AN and SAT Ground Station (GND) in the wireless communication network that automatically terminates the API subscriptions.

FIG. 10 illustrates an exemplary Network Function Virtualization Infrastructure (NFVI) in the wireless communication network that automatically terminates the API subscriptions.

FIG. 11 illustrates an exemplary operation of the wireless communication network to automatically terminate the API subscriptions.

### DETAILED DESCRIPTION

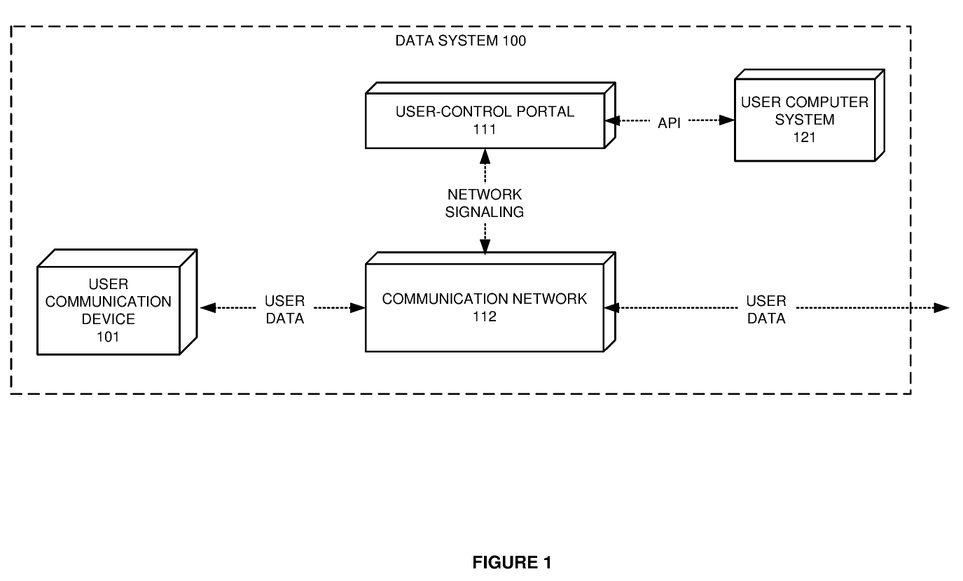

FIG. 1 illustrates exemplary data system 100 to automatically terminate Application Programming Interface (API) subscriptions. Data system 100 delivers data communication services like social networking, media streaming, machine control, environmental monitoring, and/or some other data product. Data system 100 comprises user communication device 101, user-control portal 111, communication network 112, and user computer system 121. User communication device 101 comprises a phone, computer, vehicle, robot, sensor, and/or some other user apparatus with data communication components. User-control portal 111 and communication network 112 comprise network functions like a Network Exposure Function (NEF), User Plane Function (UPF), and/or some other network elements. For example, user-control portal 111 may comprise a NEF and an AF, and communication network 112 may comprise a Session Management Function (SMF) and a User Plane Function (UPF). User computer system 121 comprises an application server and/or some other data processing system with a user interface.

In some examples, user-control portal 111 activates an API subscription that will be used to support user communication device 101. To activate the API subscription, user-control portal 111 may receive a user request into an AF which responsively obtains the API subscription from a NEF. User-control portal 111 determines a termination condition for automatically terminating the API subscription. User-control portal 111 receives a user request and responsively calls the subscribed API to modify a data communication service for user communication device 101. In response, user-control portal 111 directs communication network 112 to modify the data communication service for user communication device 101. Communication network 112 modifies the data communication service for user communication device 101. For example, communication network 112 may increase the data rate and decrease the latency of a wireless communication link. Subsequently, user-control portal 111 detects that the termination condition has been met. In response to the detection, user-control portal 111 automatically terminates the API subscription is reached. The termination condition may comprise an expiry of a time duration and/or an amount of API usage. For example, the API subscription may have a 24-hour duration and is automatically terminated after 24 hours. In another example, the API subscription may have a 100call limit and is automatically terminated after 24 API calls.

User-control portal 111 may determine and detect termination conditions that are specific to the API subscription, user communication device 101, and/or the wireless communication link between user communication device 101 and communication network 112. For example, the duration of one API subscription or wireless link may be different than the other durations for other API subscriptions or wireless links. In another example, the amount of API usage before subscription termination for one AF or user communication device may be different than the amount of API usage before subscription termination for other AFs or other user communication devices. User-control portal 111 may determine other termination conditions for other user communication devices, API subscriptions, and/or wireless communication links.

In some examples, an AF receives a user request from user computer system 121 and responsively transfers the API subscription request to a Network Exposure Function (NEF). The NEF activates the API subscription for user communication device 101. The NEF determines the termination condition for automatically terminating the API subscription. The AF receives a user request and responsively calls the API to modify the quality-of-service of a wireless communication bearer for user communication device 101. The AF transfers the API call to the NEF. The NEF transfers signaling to a wireless network element to modify the quality-of-service of the wireless communication bearer for user communication device 101 in response to the API call. The NEF determines that the termination condition has been met, and in response, automatically terminates the API subscription. The API subscription may comprise an “AsSessionWithQoS” subscription.

In some examples, user communication device 101 and communication network 112 wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), satellite data communications and/or some other wireless protocol. User communication device 101, user-control portal 111, communication network 112, and user computer system 121 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data system 100 as described herein.

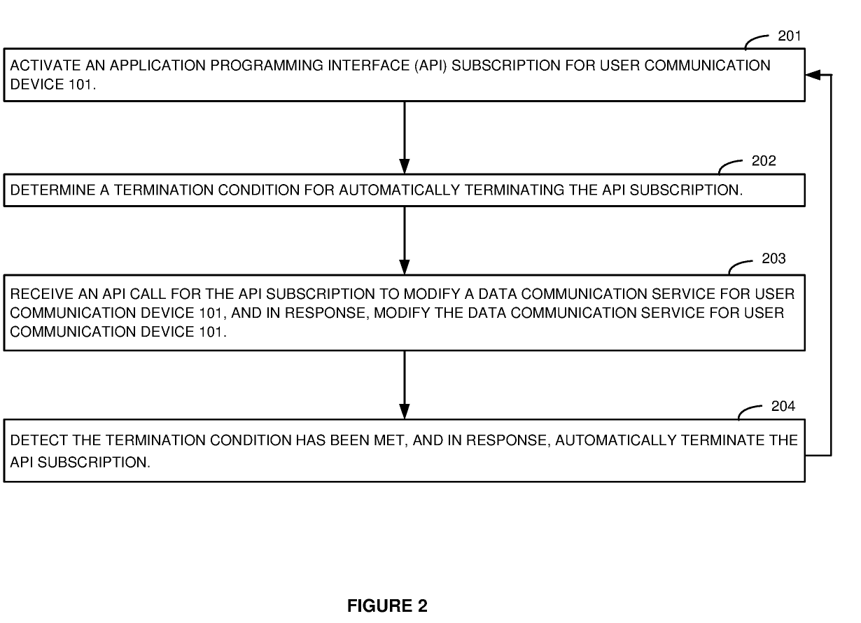

FIG. 2 illustrates an exemplary operation of data system 100 to automatically terminate the API subscriptions. The operation may differ in other examples. Activate an API subscription for user communication device 101 (201). Determine a termination condition for automatically terminating the API subscription (202). Receive an API call for the API subscription to modify a data communication service for user communication device 101, and in response, modify the data communication service for user communication device 101 (203). Detect the termination condition has been met, and in response, automatically terminate the API subscription (204). The operation repeats (201).

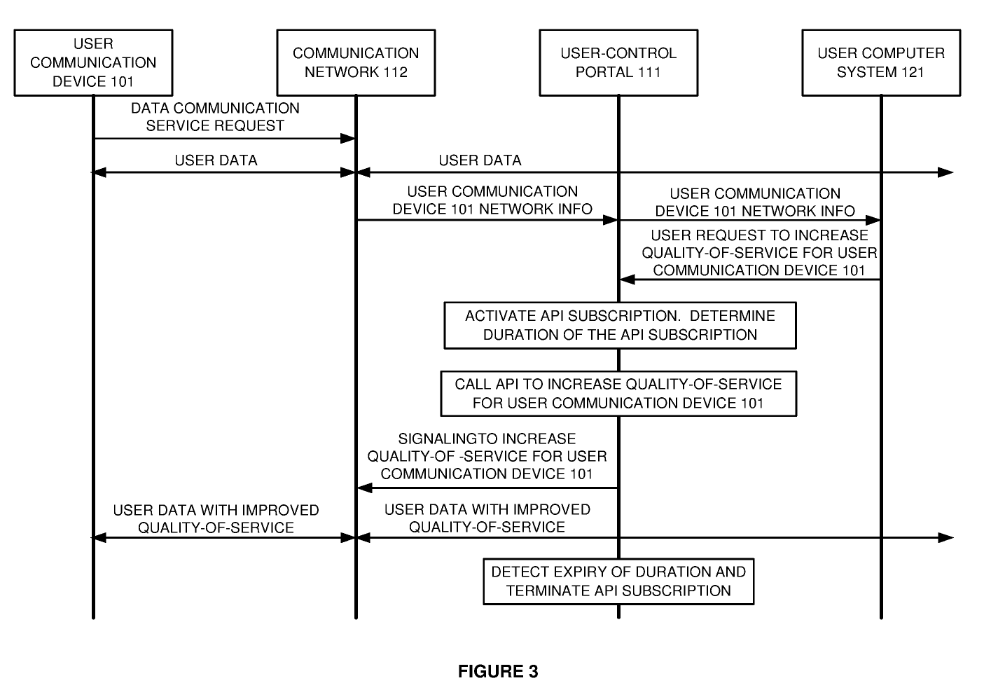

FIG. 3 illustrates an exemplary operation of data system 100 to automatically terminate the API subscriptions. The operation may differ in other examples. User communication device 101 transfers a data communication service request to communication network 112. In response to the request, communication network 112 exchanges user data between user communication device 101 and external data systems (not shown). Communication network 112 transfers network information for user communication device 101 to user-control-portal 111. The network information may indicate network addresses, quality-of-service, and the like. User-control portal 111 transfers network information for user communication device 101 to user computer system 121. In response to the network information, user computer system 121 transfers a user request to increase the quality-of-service for user communication device 101. In response to the user request, user-control portal 111 activates an API subscription for user communication device 101. User-control portal 111 determines a duration for the API subscription. User-control portal 111 calls an API to increase the quality-of-service for user communication device 101. In response to the API call, user-control portal 111 transfers signaling to communication network 112 to increase the quality-of-service for user communication device 101. In response to the signaling, communication network 112 uses the increased quality-of-service to exchange user data between user communication device 101 and the external data systems. User-control portal 111 detects the expiry of the duration for the API subscription, and in response, user-control portal 111 automatically terminates the API subscription.

Advantageously, data system 100 efficiently uses API subscriptions to improve service quality for data communication users. Moreover, data system 100 effectively terminates the API subscriptions to avoid maintaining costly API subscriptions that are no longer needed.

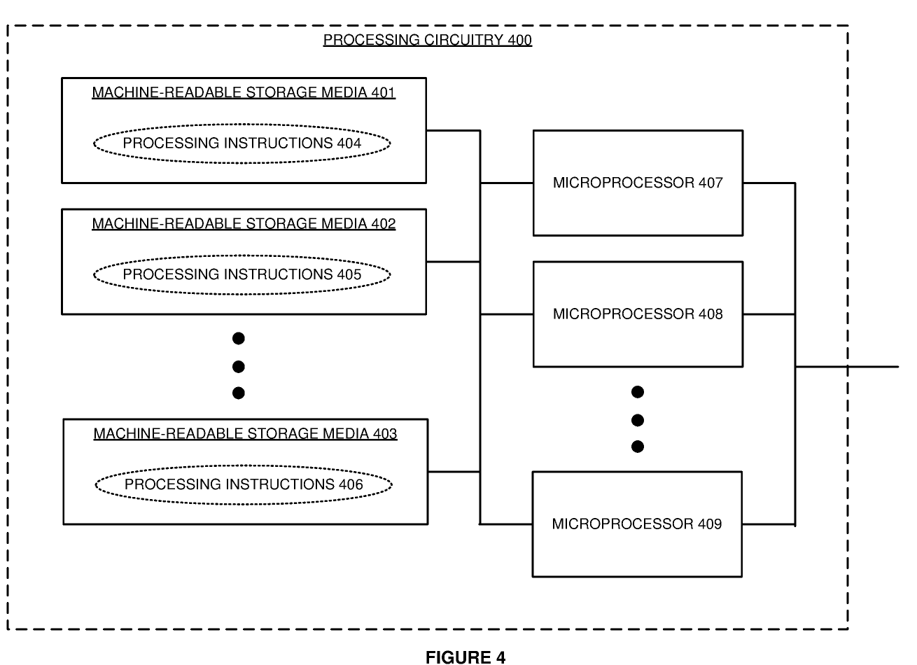

FIG. 4 illustrates exemplary processing circuitry 400 to automatically terminate API subscriptions. Processing circuitry 400 comprises an example of user-control portal 111 and/or communication network 112, although portal 111 and/or network 112 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to automatically terminate API subscriptions as described above for data system 100 and as described below for wireless communication network 500. The amount of storage media, microprocessors, processing instructions that are shown in FIG. 4 may vary in other examples.

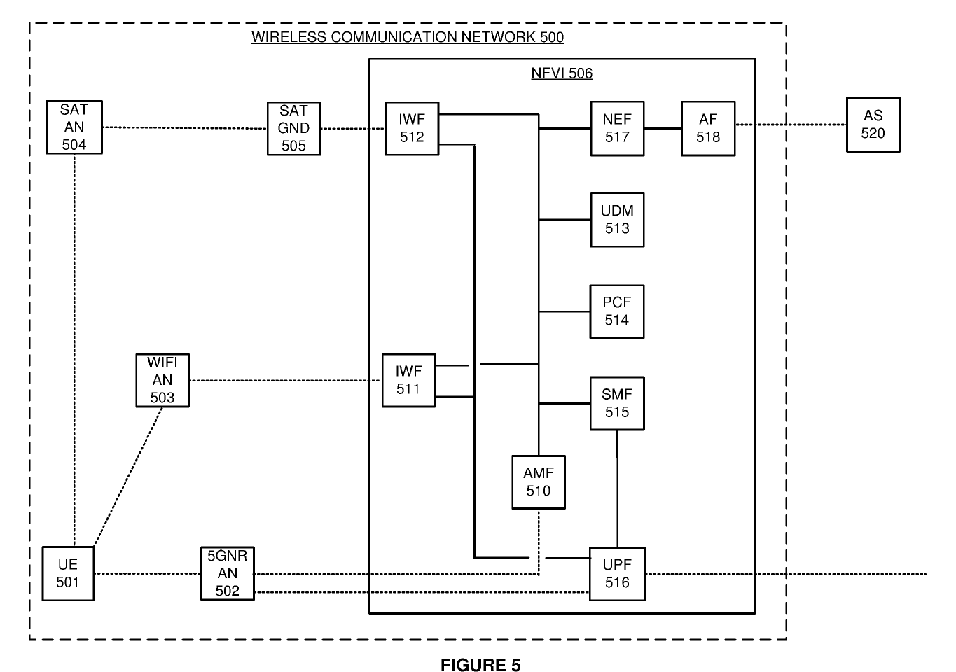

FIG. 5 illustrates exemplary wireless communication network 500 to automatically terminate API subscriptions. Wireless communication network 500 comprises an example of data system 100 and processing circuitry 400, although system 100 and circuitry 400 may differ. Wireless communication network 500 comprises User Equipment (UE) 501, Fifth Generation New Radio (5GNR) AN 502, Wireless Fidelity (WIFI) AN 503, earth satellite (SAT) AN 504, satellite ground station (SAT GND) 505, and Network Function Virtualization Infrastructure (NFVI) 506. NFVI 506 comprises Access and Mobility Management Function (AMF) 510, Interworking Functions (IWFs) 511-512, and Unified Data Management (UDM) 513, Policy Control Function (PCF) 514, Session Management Function (SMF) 515, User Plane Function (UPF) 516, Network Exposure Function (NEF) 517, and Application Function (AF) 518. AF 518 is linked to Application Server (AS) 520. AS 520 is associated with UE 501. For example, UE 501 could be one vehicle in a large fleet of vehicles, and AS 520 could be used to monitor and support the vehicles.

UE 501 registers with AMF 510 over SAT AN 504, SAT GND 505, and IWF 512. AMF 510 interacts with UDM 513 to perform the registration. AMF 510 interacts with PCF 514 to obtain policies for UE 501. AMF 510 interacts with SMF 515 to develop context for UE 501 based on the registration and policies. The context indicates network addresses, quality-of-service, and other session characteristics. SMF 515 transfers the context to UPF 516. AMF 510 transfers the context to IWF 512, SAT GND 505, and SAT AN 504. AMF 510 transfers the context to UE 501 over IWF 512, SAT GND 505, and SAT AN 504. In response to the context, UE 501 exchanges user data with an external data system (not shown) over SAT AN 504, SAT GND 505, IWF 512, and UPF 516.

SMF 515 transfers network information for UE 501 to NEF 517. NEF 517 transfers the network information for UE 501 to AS 520 over AF 518. The network information indicates data rate and latency for UE 501. In response to the network information, AS 520 transfers a request to AF 518 for better QoS for UE 501. AF 518 obtains an API subscription from NEF 517 to implement the user request. NEF 517 determines a time duration for the API subscription. Using the API subscription, AF 518 calls an API on NEF 517 to deliver better QoS to UE 501. In response to the API call, NEF 517 transfers network signaling to SMF 515 to increase the QoS for UE 501. In response to the signaling, SMF 515 and AMF 510 develop additional context for the increased QoS. SMF 515 transfers the additional context to UPF 516. AMF 510 transfers the additional context to IWF 512, SAT GND 505, and SAT AN 504. AMF 510 transfers the additional context to UE 501 over IWF 512, SAT GND 505, and SAT AN 504. In response to the additional context, UE 501 exchanges user data with the external data system over SAT AN 504, SAT GND 505, IWF 512, and UPF 516 using the better QoS in the additional context. For example, UE 501 may get a higher data rate and lower latency.

Subsequently, NEF 517 detects that the time duration for the API subscription has expired, and in response, NEF 517 automatically terminates the API subscription. The API subscription may still have been active in NEF 517 because a signaling message to terminate the API subscription from PCF 514 to NEF 517 was lost or mishandled. Alternatively, the API subscription may still have been active in NEF 517 because a signaling message to terminate the API subscription from AF 518 to NEF 517 was lost or mishandled. In either case, the unwanted API subscription is automatically terminated by NEF 517.

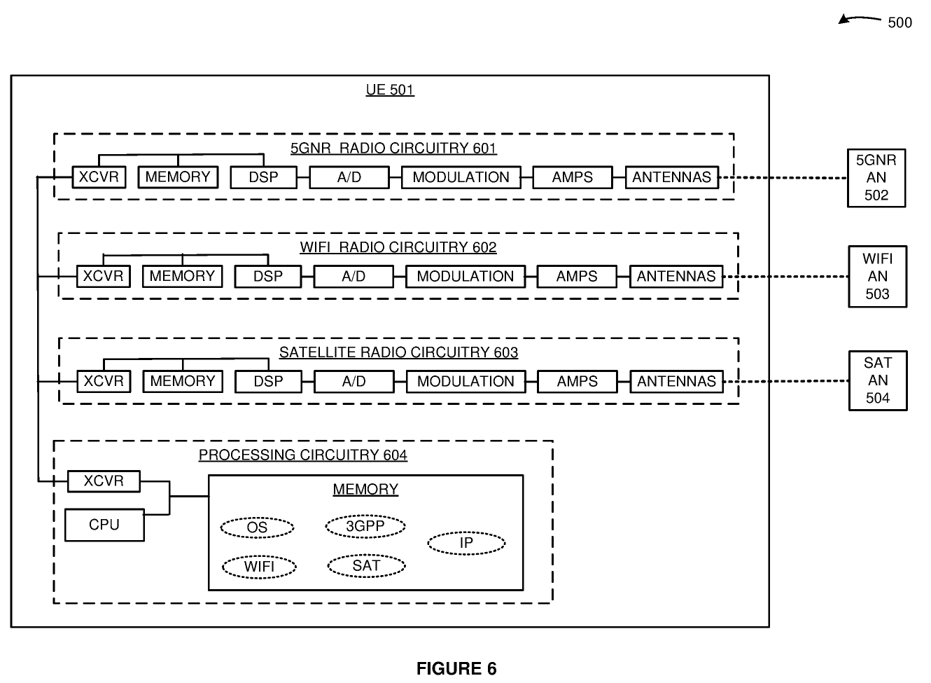

FIG. 6 illustrates exemplary User Equipment (UE) 501 in wireless communication network 500 that automatically terminates the API subscriptions. UE 501 comprises an example of user communication device 101, although device 101 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 3GPP Application (3GPP), WIFI Application (WIFI), Satellite Application (SAT), and Internet Protocol Application (IP). The antennas in radio circuitry 601-603 exchange wireless signals with ANs 502-504. Transceivers in radio circuitry 601-603 are coupled to transceivers in processing circuitry 604. In processing circuitry 604, the one or more CPUs retrieve the software from the one or more memories and execute the software to direct the operation of UE 501 as described herein.

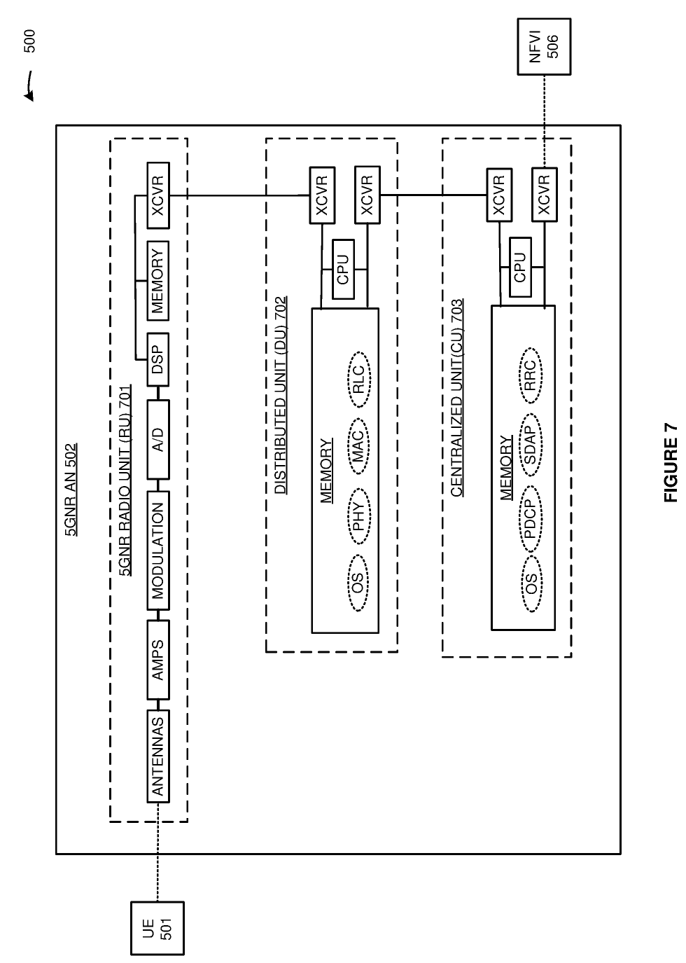

FIG. 7 illustrates exemplary terrestrial 5GNR AN 502 in wireless communication network 500 that automatically terminates the API subscriptions. 5GNR AN 502 comprises an example of communication network 112 and processing circuitry 400, although network 112 and circuitry 400 may differ. 5GNR AN 502 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, transceivers, and power supply (PWR) that are coupled over bus circuitry. DU 702 comprises memory, CPU, transceivers, and power supply that are coupled over bus circuitry. The memory in DU 702 stores operating system and 5GNR network applications for Physical Layer (PHY), Media Access Control (MAC), and Radio Link Control (RLC). CU 703 comprises memory, CPU, transceivers, and power supply that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to UE 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 506. The DSP and CPU in RU 701, DU 702, and CU 703 execute the radio applications, operating systems, and network applications to exchange data and signaling between UE 501 and NFVI 506 as described herein.

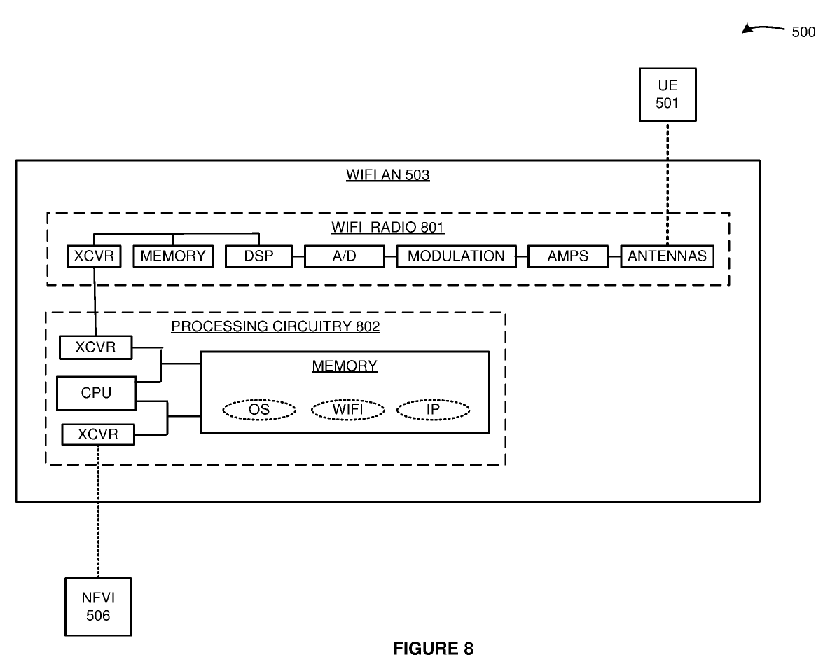

FIG. 8 illustrates exemplary Wireless Fidelity (WIFI) AN 503 in wireless communication network 500 that automatically terminates the API subscriptions. WIFI AN 503 comprises an example of communication network 112 and processing circuitry 400, although network 112 and circuitry 400 may differ. WIFI AN 503 comprises WIFI radio 801 and processing circuitry 802. Radio 801 comprises antennas, amplifiers, filters, modulation, analog-to-digital interfaces, DSPs, memories, transceivers, and power supply that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UE 501. Transceivers in radio 801 are coupled to transceivers in processing circuitry 802. Transceivers in processing circuitry 802 are coupled to transceivers in NFVI 506. In processing circuitry 802, the one or more CPUs retrieve the software from the one or more memories and execute the software to exchange data and signaling between UE 501 and NFVI 506 as described herein.

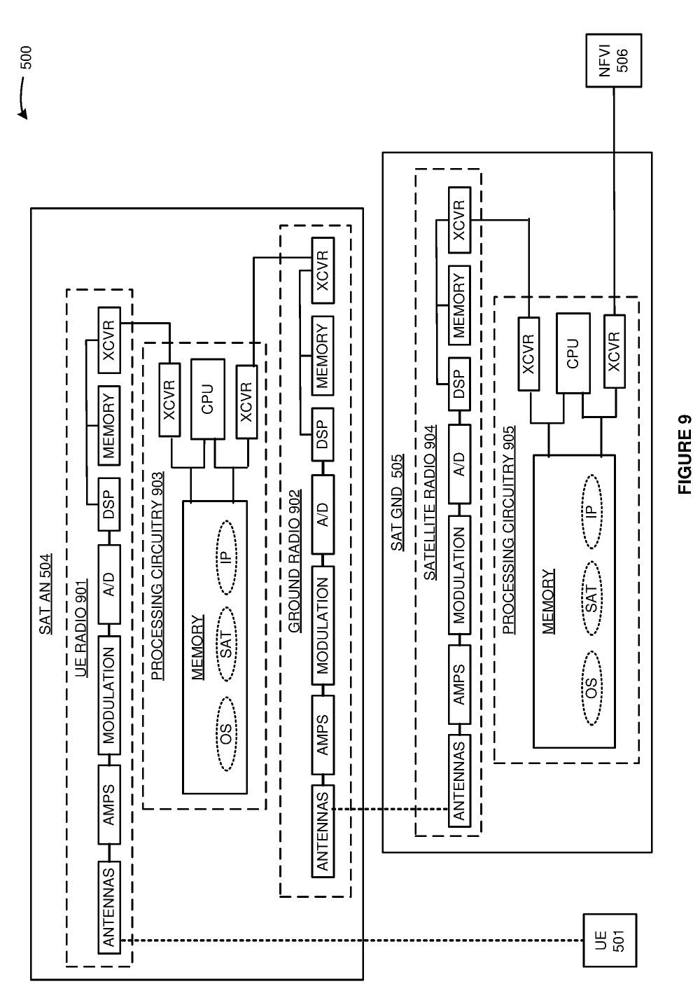

FIG. 9 illustrates exemplary Satellite (SAT) AN 504 and SAT Ground Station (GND) 505 in wireless communication network 500 that automatically terminates the API subscriptions. SAT AN 504 and SAT GND 505 comprise an example of wireless communication network 112, although network 112 and circuitry 400 may differ. SAT AN 504 comprises UE radio 901, ground radio 902, and processing circuitry 903. SAT GND 505 comprises satellite radio 904 and processing circuitry 905. Radios 901-902 and 904 comprise antennas, amplifiers, filters, modulation, analog-to-digital interfaces, DSPs, memories, transceivers, and power supplies that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UEs 501. Transceivers in UE radio 901 are coupled to transceivers in processing circuitry 903. Transceivers in processing circuitry 903 are coupled to transceivers in ground radio 902. The antennas in ground radio 902 exchange satellite signals with antennas in satellite radio 904, and the antennas in satellite radio 904 exchange the satellite signals with ground radio 902. Transceivers in satellite radio 904 are coupled to transceivers in processing circuitry 905. Transceivers in processing circuitry 905 are coupled to transceivers in NFVI 506. In processing circuitry 903 and 905, the one or more CPUs retrieve the software from the one or more memories and execute the software to exchange data and signaling between UE 501 and NFVI 506 as described herein.

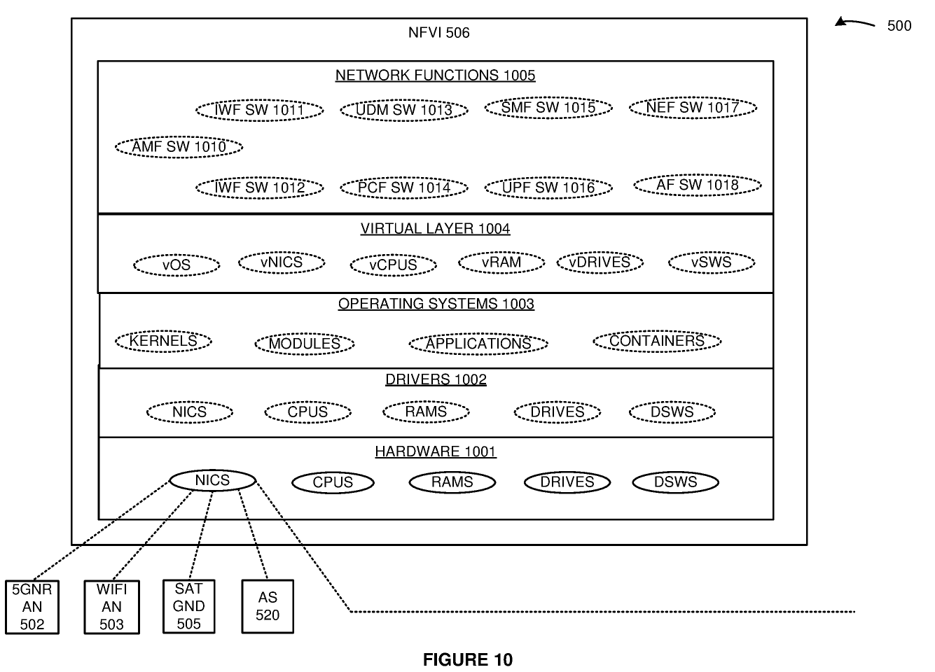

FIG. 10 illustrates exemplary Network Function Virtualization Infrastructure (NFVI) 506 in wireless communication network 500 that automatically terminates the API subscriptions. NFVI 506 comprises an example of user-control portal 111, communication network 112, and processing circuitry 400, although portal 111, network 112, and circuitry 400 may differ. NFVI 506 comprises hardware 1001, hardware drivers 1002, operating systems 1003, virtual layer 1004, and network functions 1005. Hardware 1001 comprises Network Interface Cards (NICS), TPMs, CPUs, RAM, Flash/Disk Drives (DRIVES), and Data Switches (DSWS). Hardware drivers 1002 comprise software that is resident in the NICS, TPMs, CPUs, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises AMF SW 1010, IWF SW 1011-1012, UDM SW 1013, PCF SW 1014, SMF SW 1015, UPF SW 1016, NEF SW 1017, and AF SW 1017. The NICS in hardware 1001 are coupled to ANs502-503, SAT GND 505, and external systems. Hardware 1001 executes hardware drivers 1002, operating systems 1003, virtual layer 1004, and network functions 1005 to form and operate AMF 510, IWFs511-512, UDM 513, PCF 514, SMF 515, UPF 516, NEF 517, and AF 518 as described herein. NFVI 506 may be located at a single site or be distributed across multiple geographic areas. In particular, NEF SW 1017 automatically terminates API subscriptions based on API time duration, API usage, or some other condition.

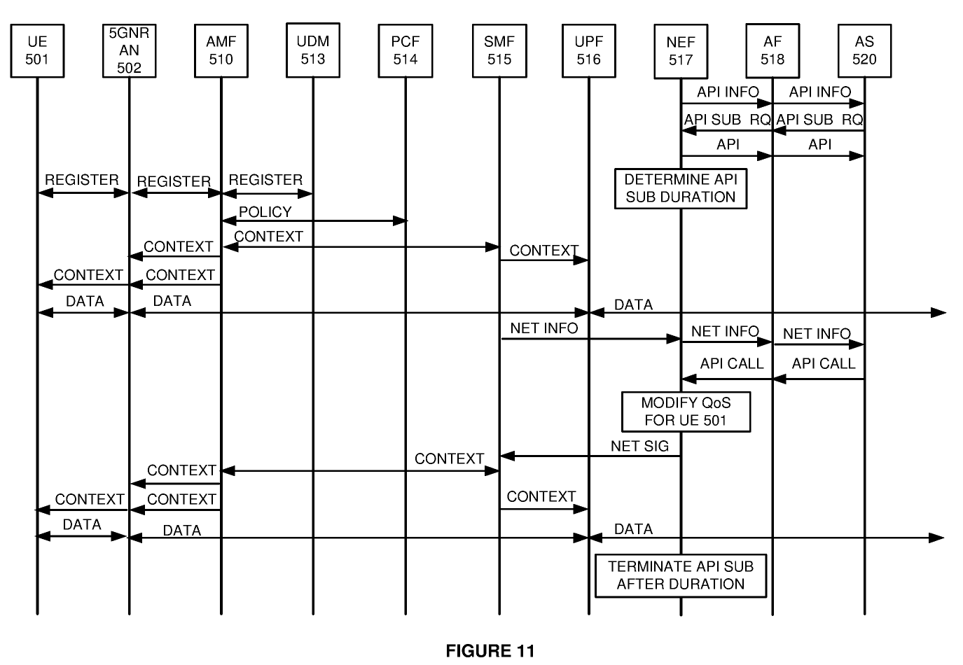

FIG. 11 illustrates an exemplary operation of wireless communication network 500 to automatically terminate the API subscriptions. In this example, the APIs are extended to AS 520. The operation may differ in other examples. NEF 517 transfers API information to AS 520 over AF 518. The API information describes the APIs that are available from NEF 517. AS 530 responds to NEF 517 over AF 518, and the response includes a subscription request (SUB RQ) for one of the APIs. NEF 517 transfers the requested API to AS 520 over AF 518. NEF 517 also determines a time duration for the API subscription.

UE 501 registers with AMF 510 over 5GNR AN 502, and AMF 510 interacts with UDM 513 to perform the registration. AMF 510 interacts with PCF 514 to obtain policies for UE 501. AMF 510 interacts with SMF 515 to develop context for UE 501 based on the registration and policies. The context indicates network addresses, quality-of-service, and other session characteristics. SMF 515 transfers the context to UPF 516. AMF 510 transfers the context to 5GNR AN 502. AMF 510 transfers the context to 5GNR AN 502. AMF 510 transfers the context to UE 501 over 5GNR AN 502. In response to the context, UE 501 exchanges user data with an external data system (not shown) over 5GNR AN 502 and UPF 516.

SMF 515 transfers network information (NET INFO) for UE 501 to NEF 517. NEF 517 transfers the network information for UE 501 to AS 520 over AF 518. The network information indicates data rate and latency for UE 501. In response to the network information, AS 520 transfers an API call to NEF 517 over AF 518. The API call requests that UE 501 get better QoS. In response to the API call, NEF 517 transfers network signaling (NET SIG) to SMF 515 to increase the QoS for UE 501. In response to the signaling, SMF 515 and AMF 510 develop additional context for the increased QoS. SMF 515 transfers the additional context to UPF 516. AMF 510 transfers the additional context to 5GNR AN 502. AMF 510 transfers the additional context to UE 501 over 5GNR AN 502. In response to the additional context, UE 501 exchanges user data with the external data system over 5GNR AN 502 and UPF 516 using the better QoS in the additional context. For example, UE 501 may get a higher data rate and lower latency.

Subsequently, NEF 517 detects that the time duration for the API subscription has expired, and in response, NEF 517 automatically terminates the API subscription. The API subscription may still have been active in NEF 517 because a signaling message to terminate the API subscription from PCF 514 to NEF 517 was lost or mishandled. Alternatively, the API subscription may still have been active in NEF 517 because a signaling message to terminate the API subscription from AF 518 to NEF 517 was lost or mishandled. In either case, the unwanted API subscription is automatically terminated by NEF 517.

Advantageously, NEF 517 efficiently serves API subscriptions to AS 520. Moreover, NEF 517 effectively terminates the API subscriptions to avoid maintaining costly API subscriptions that are not needed.

The wireless communication system circuitry described above comprises computer hardware and software that form special-purpose data communication circuitry to automatically terminate API subscriptions. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry to automatically terminate API subscriptions.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
activating an Application Programming Interface (API) subscription;
determining a termination condition for automatically terminating the API subscription;
receiving an API call for the API subscription to modify a data communication service for a user communication device;
modifying the data communication service for the user communication device in response to the API call; and
detecting the termination condition has been met, and in response, automatically terminating the API subscription for the user communication device.

2. The method of claim 1 wherein:
the data communication service comprises a wireless communication link; and
modifying the data communication service comprises modifying quality-of-service of the wireless communication link.

3. The method of claim 1 wherein the termination condition comprises an expiry of a time duration.

4. The method of claim 1 wherein the termination condition comprises an amount of API usage.

5. The method of claim 1 wherein:
determining the termination condition comprises determining a corresponding termination condition that is specific to the API subscription; and
detecting the termination condition has been met comprises detecting that the corresponding termination condition that is specific to the API subscription has been met; and wherein
the corresponding termination condition differs from other termination conditions of other API subscriptions.

6. The method of claim 1 wherein:
determining the termination condition comprises determining a corresponding termination condition that is specific to the user communication device; and
detecting the termination condition has been met comprises detecting that the corresponding termination condition that is specific to the user communication device has been met; and wherein
the corresponding termination condition differs from other termination conditions of other user communication devices.

7. The method of claim 1 wherein:
the data communication service comprises a wireless communication link;
determining the termination condition comprises determining a corresponding termination condition that is specific to the wireless communication link; and
detecting the termination condition has been met comprises detecting that the corresponding termination condition that is specific to the wireless communication link has been met; and wherein
the corresponding termination condition differs from other termination conditions of other wireless communication links.

8. The method of claim 1 wherein:
activating the API subscription comprises activating the API subscription in response to receiving a request for the API subscription from an Application Function (AF);
receiving the API call comprises receiving the API call from the AF;
determining the termination condition comprises determining a corresponding termination condition that is specific to the AF; and wherein
the corresponding termination condition differs from other termination conditions of other AFs.

9. A method comprising:
an Application Function (AF) receiving a user request and responsively transferring an Application Programming Interface (API) subscription request to a Network Exposure Function (NEF);
the NEF activating an API subscription for the AF in response to the subscription request;
the NEF determining a termination condition for automatically terminating the API subscription;
the AF transferring an API call to modify quality-of-service of a wireless communication bearer for the user communication device to the NEF;
the NEF signaling a wireless network element to modify the quality-of-service of the wireless communication bearer for the user communication device in response to the API call; and
the NEF determining that the termination condition has been met, and in response, automatically terminating the API subscription.

10. The method of claim 9 wherein the API subscription comprises an AsSessionWithQoS API subscription.

11. The method of claim 9 wherein the termination condition comprises a time duration.

12. A data system comprising:
a user-control portal to activate an Application Programming Interface (API) subscription;
the user-control portal to determine a termination condition for automatically terminating the API subscription;
the user-control portal to receive an API call for the API subscription to modify a data communication service for a user communication device, and in response, to direct a communication network to modify the data communication service for the user communication device;
the communication network to modify the data communication service for the user communication device; and
the user-control portal to detect the termination condition has been met, and in response, automatically terminate the API subscription for the user communication device.

13. The data system of claim 12 wherein:
the data communication service comprises a wireless communication link; and
the communication network is to modify quality-of-service of the wireless communication link to modify the data communication service.

14. The data system of claim 12 wherein the termination condition comprises an expiry of a time duration.

15. The data system of claim 12 wherein the termination condition comprises an amount of API usage.

16. The data system of claim 12 wherein:
the user-control portal is to determine a corresponding termination condition that is specific to the API subscription;
the user-control portal is to detect that the corresponding termination condition that is specific to the API subscription has been met; and
the user-control portal is to determine other termination conditions for other API subscriptions.

17. The data system of claim 12 wherein:
the user-control portal is to determine a corresponding termination condition that is specific to the user communication device; and
the user-control portal is to detect that the corresponding termination condition that is specific to the user communication device has been met; and
the user-control portal is to determine other termination conditions for other user communication devices.

18. The data system of claim 12 wherein:
the data service comprises a wireless communication link;
the user-control portal is to determine a corresponding termination condition that is specific to the wireless communication link;
the user-control portal is to detect that the corresponding termination condition that is specific to the wireless communication link has been met; and
the user-control portal is to determine other termination conditions for other wireless communication links.

19. The data system of claim 12 wherein the user-control portal comprises an Application Function (AF) and a Network Exposure Function (NEF).

20. The data system of claim 12 wherein the communication network comprises a Session Management Function (SMF) and a User Plane Function (UPF).
